(19) United States
(12) Patent Application Publication
(10) Pub. No.: US 2003/0153329 A1
(43) Pub. Date: Aug. 14, 2003

(54) Method for broadcast filtering using convex hulls

(75) Inventors: Jeffrey M. Stefan, Clawson, MI (US); Jasmin Jijina, West Bloomfield, MI (US)

Correspondence Address: ANTHONY LUKE SIMON, General Motors Corporation, Legal Staff, Mail Code 482-C23-B21, 300 Renaissance Center, P.O. Box 300, Detroit, MI, 48265-3000, US

(73) Assignee: General Motors Corporation

(21) Appl. No.: 10/077,013

(22) Filed: Feb. 13, 2002

(51) Int. Cl. H04B 7/185

(52) U.S. Cl. 455/456; 342/357.1

(57) ABSTRACT

The invention provides a method of providing information to a mobile vehicle user. Broadcast information, which includes information location coordinate data, is received at the mobile vehicle. A determination is made on whether the information location coordinate data resides within a convex hull, and then, based on that determination, the broadcast information is presented to the mobile vehicle user.

### FIELD OF THE INVENTION

This invention relates generally to operating a wireless communication system. More specifically, the invention relates to a method of filtering broadcasted information to a mobile vehicle, based on an algorithm using convex hulls.

### BACKGROUND OF THE INVENTION

Wireless technology, multimedia and telematics are converging to create new applications for mobile vehicle users. Nearly 50% of new cars by year 2006are expected to have telematics, which include GPS and other safety, navigational and Internet features. Emerging standards and advances in digital technology are leading to increased entertainment and information services from sources including satellite radio, terrestrial digital radio, and other wireless communication systems. Many of these broadcasts may be delivered with additional data such as station identification, song titles, program schedules, and location information with the broadcast to regionally targeted users.

Despite the growing number of sources from which a driver may receive news, entertainment and information radio, much of the broadcast information may be useless to regionally specific vehicles. With the increasing number of broadcasts available from satellite as well as terrestrial radio services, a telematics unit in an automobile needs to be able to filter regionally specific broadcasted news, weather, traffic, or road construction information based on the geographic area that a driver normally travels or is currently in. The filtering also needs to be determined by subscriber preferences, just as other telematics services are personalized or targeted based on the current location of an automobile. Undoubtedly, demand will grow for more personalized and prioritized telematics services and methods for delivering and receiving regionally specific information to individual vehicles.

Drivers would be able to make better decisions regarding travel with better real-time weather, traffic, and road construction information of the region in which an automobile regularly travels if broadcast information could be filtered for regionally specific data.

Therefore, it would be desirable to provide a method for filtering broadcasts based on the geographical area in which a mobile vehicle is currently in or regularly travels and on preferences of a telematics subscriber.

### SUMMARY OF THE INVENTION

One aspect of the invention provides a method of providing information to a mobile vehicle user. Broadcast information may be received at the mobile vehicle, wherein the broadcast information may include information location coordinate data. Whether the information location coordinate data resides within a convex hull may be determined. The broadcast information may be presented to the mobile vehicle user based on the determination. The broadcast information may be received from a broadcast service including a radio data service, a radio broadcast data service, a satellite broadcast service, a radio broadcast service, and a wireless communications broadcast service. The information location coordinate data may include a longitude and a latitude associated with the broadcast information.

A plurality of vehicle location coordinates may be recorded and the convex hull may be generated from the recorded vehicle location coordinates. The convex hull may be updated based on a coordinate input. The coordinate input may include a current vehicle location coordinate, a previous vehicle location coordinate, a recorded vehicle location coordinate input, a collection period, a collection frequency, a vehicle location coordinate retention period, a global positioning service quality indicator, and a user location coordinate input. The broadcast information may be transferred to a vehicle presentation manager. The broadcast information may be rendered with the vehicle presentation manager. The broadcast information may be presented to a presentation device. The presentation device may include a visual display, an audio device, and an audio-visual display device.

Another aspect of the invention is a computer usable medium that may include a program for providing information to a mobile vehicle user. The computer program may include code to receive broadcast information at the mobile vehicle, wherein the broadcast information comprises information location coordinate data and at least one data string. The program may include code to determine whether the information location coordinate data resides within a convex hull. The program may include code to present the broadcast information to the mobile vehicle user based on the determination.

The broadcast information may be received from a broadcast service including a radio data service, a radio broadcast data service, a satellite broadcast service, a radio broadcast service, and a wireless communications broadcast service. The information location coordinate data may include a longitude and a latitude associated with the broadcast information. The program may include code to record a plurality of vehicle location coordinates and to generate the convex hull from the recorded vehicle location coordinates. The program may include code to update the convex hull based on a coordinate input. The coordinate input may include a current vehicle location coordinate, a previous vehicle location coordinate, a recorded vehicle location coordinate input, a collection period, a collection frequency, a vehicle location coordinate retention period, a global positioning service quality indicator, and a user location coordinate input.

The program may include code to transfer the broadcast information to a vehicle presentation manager to render the broadcast information with the vehicle presentation manager and to send the broadcast information to a presentation device. The presentation device may be selected from a group consisting of a visual display, an audio device, and an audio-visual display device.

Another aspect of the invention is a system for providing information to a mobile vehicle user including means for receiving broadcast information at the mobile vehicle, wherein the broadcast information comprises information location coordinate data and at least one data string; means for determining whether the information location coordinate data resides within a convex hull; and means for presenting the broadcast information to the mobile vehicle user based on the determination.

The system may include means for recording a plurality of vehicle location coordinates, and means for generating the convex hull from the recorded vehicle location coordinates. The system may include means for updating the convex hull based on a coordinate input. The system may include means for transferring the broadcast information to a vehicle presentation manager, means for rendering the broadcast information with the vehicle presentation manager, and means for sending the broadcast information to a presentation device.

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is an illustration of one embodiment of a system for filtering broadcast information using convex hulls, in accordance with the current invention;

FIG. 2 is an illustration of one embodiment of a method for filtering broadcast information using a convex hull, in accordance with the current invention; and

FIG. 3 is a flow diagram of another embodiment of a method for filtering broadcast information using convex hulls, in accordance with the current invention.

### DETAILED DESCRIPTION OF THE PRESENTLY PREFERRED EMBODIMENTS

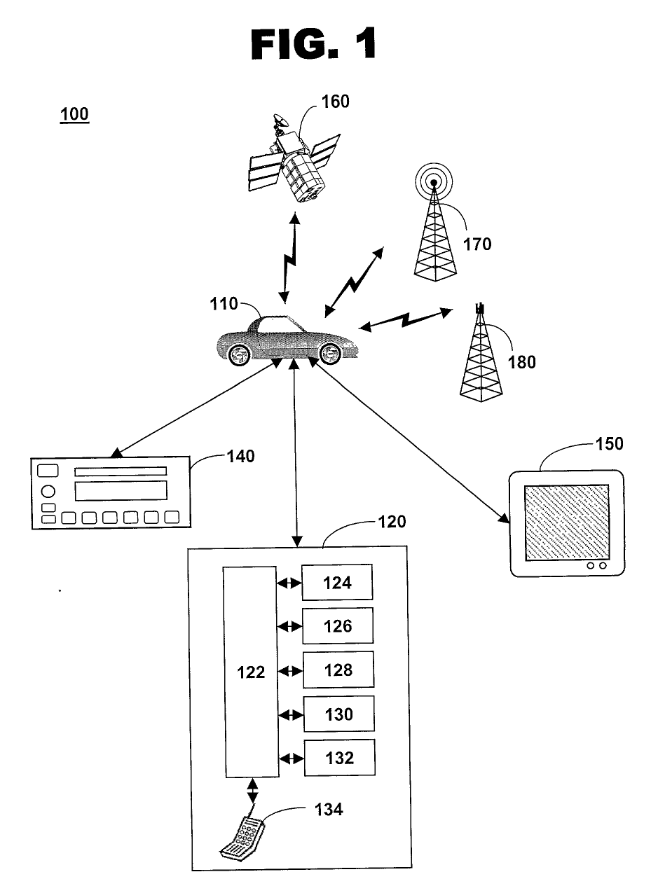

FIG.1 shows an illustration of one embodiment of an in-vehicle system for filtering broadcast information using convex hulls, in accordance with the present invention at 100. One aspect of the invention is a system for filtering out information from a satellite, radio, or wireless communication broadcast that is targeted to or appropriate for the mobile vehicle user based on the current or previous geographical location of the mobile vehicle.

The broadcast may be transmitted from a number of different sources including radio, satellite and wireless communications broadcast services that include geographical location coordinates in their broadcast signals. The geographical location coordinates may be used by a receiver to filter information or advertisements targeted to recipients in a specific geographical region. The filtering of broadcasts based on targeted geographic locations, as determined by a convex hull algorithm, may occur in a digital signal processor of an in-vehicle telematics unit.

Broadcast filtering system 100 may include a mobile vehicle 110, a telematics unit 120, one or more audio devices 140, one or more visual display devices 150, one or more satellite broadcast systems 160, one or more radio broadcast systems 170, and one or more wireless communication systems 180.

Mobile vehicle 110 may be a mobile vehicle equipped with suitable hardware and software for transmitting and receiving voice and data communications. Mobile vehicle 110 may contain telematics unit 120 that may include a vehicle communications processor. Telematics unit 120 may include a digital signal processor (DSP) 122 connected to a wireless analog, digital or dual-mode modem 124, a global positioning system (GPS) unit 126, an in-vehicle memory 128, a microphone 130, one or more speakers 132, and a network access device (NAD) or in-vehicle mobile phone 134. In-vehicle mobile phone 134 may be an analog, digital, or dual-mode cellular phone. GPS unit 126 may provide, for example, longitude and latitude coordinates of the vehicle.

DSP 122 may contain various computer programs that control programming and operational modes of various applications within mobile vehicle 110. A voice-recognition application may be installed in DSP 122 that may translate human voice input through microphone 130 to digital signals. These signals may activate the programming mode and operation modes, as well as provide input data. Output signals from DSP 122 may be transformed into digitized voice messages that may be sent out through speaker 132. DSP 122 may include one or more computer applications to process and manage broadcast information that is received from a broadcast service such as a radio data service, a radio broadcast data service, a satellite broadcast service, a radio broadcast service, or a wireless communications broadcast service.

Audio device 140 may be any suitable hardware for receiving broadcast signals in mobile vehicle 110. Audio device 140 may receive radio broadcasts from satellite broadcast system 160, radio broadcast system 170, and wireless communication system 180. Audio device 140 may receive digital signals from telematics unit 120 to create audio output. Audio device 140 may receive digital signals from telematics unit 120 that are filtered from various types of satellite, radio, or wireless communication broadcast signals. Audio device 140 may include an audio receiver, an audio speaker, a synthesized voice output, or an audio channel. Audio device 140 may be, for example, a set of headphones or the audio portion of a television or a display device. Audio device 140 may be combined into one unit with visual display device 150 as well as other devices such as videotape, digital video, compact disk, audio tape players, car radios or a car stereo.

Visual display device 150 may receive digital signals from telematics unit 120 to provide display output. The visual display device may be, for example, a liquid crystal display, a heads-up display, a flat-panel display, a display monitor, or a visual device combined with an audio device.

Telematics unit 120 may filter and send signals that are received from satellite broadcasts, radio broadcasts or other wireless communication systems to output devices such as speaker 132, audio device 140, and visual display device 150. Telematics unit 120 may contain a vehicle presentation manager that may manage the broadcast data and render or place the broadcast information into a form suitable for presentation by audio device 140 or visual display device 150.

Satellite broadcast system 160 may transmit radio signals to telematics unit 120 and audio device 140 or visual display device 150 in mobile vehicle 110. Satellite broadcast system 160 may broadcast, for example, over a spectrum in the “S” band (2.3 GHz) that has been allocated by the U.S. Federal Communications Commission (FCC) for nationwide broadcasting of satellite-based Digital Audio Radio Service (DARS).

Radio broadcast system 170 may transmit radio signals with data to telematics unit 120 in mobile vehicle 110. Radio broadcast system 170 may transmit analog audio and/or video signals, such as those sent from AM and FM radio stations and transmitters, or digital audio signals in the S band (approved for use in the U.S.) and L band (used in Europe and Canada). Telematics unit 120 may store or retrieve data and information from the audio and/or video signals of radio broadcast system 170.

Wireless communication system 180 may incorporate any type of telecommunications in which electromagnetic waves carry signal over part or the entire communication path. Wireless communication system 180 may be any type of broadcast communication in addition to those of satellite broadcast system 160 and radio broadcast system 170. One example of such wireless communications is a short message service, modeled after established protocols such as IS-637 SMS standards, IS-136 air interface standards for SMS, and GSM 03.40 and 09.02 standards. Similar to paging, an SMS communication could be broadcast to a number of regional recipients.

Broadcast services provided by satellite broadcast system 160, radio broadcast system 170, and wireless communication system 180 may be received by telematics unit 120 in mobile vehicle 110. Broadcast services may include traffic information, road construction information, advertisements, news and information on local events. Targeted regional information from these broadcast and communication systems may be communicated to mobile vehicle user by means of in-vehicle audio device 140, visual display device 150, or some combination of both in mobile vehicle 110 as managed by telematics unit 120. Effective filtering of consequential information may be based on the development and determination of a geographical region that a mobile vehicle user is currently in or interested in receiving information about.

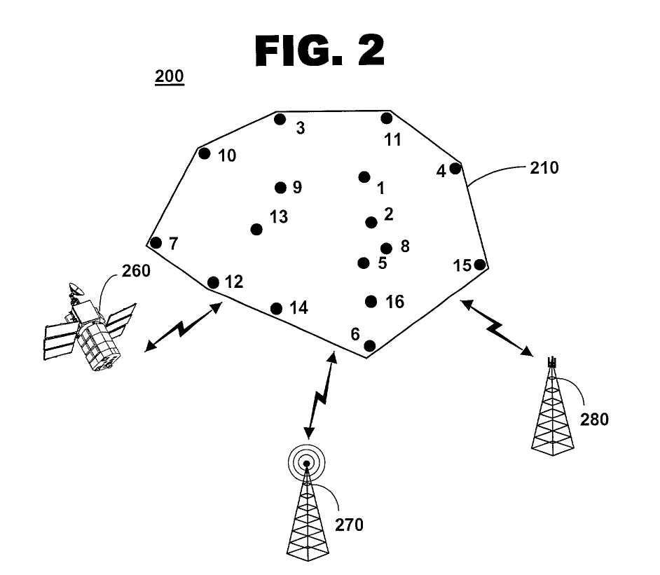

FIG. 2 shows an illustration of one embodiment of a method for filtering broadcast information using a convex hull, in accordance with the present invention at 200. Broadcast filtering method 200 may use a convex hull algorithm incorporating data from an in-vehicle GPS unit to help determine the geographical area in which a mobile vehicle user typically drives or currently is located. The method may determine whether the location coordinate data that is sent along with a broadcast signal resides within the geographical region defined by a convex hull, and then it may filter broadcasts based on that determination. For example, when the mobile vehicle is currently within the area defined by the convex hull, broadcasted information specific to that region may be received and conveyed to the user. When the mobile vehicle is not currently within the region defined by the convex hull, the user still may receive, for example, information targeted for the convex hull region at the user's preference. More than one convex hull may be used to define preferred geographical areas for receiving targeted broadcast information. The convex hull may be built up over time and evolve with the driving habits and preferences of the telematics subscriber.

A computer application in the digital signal processor of the telematics unit may receive and store a plurality of longitudinal and latitudinal coordinate positions from the GPS unit of the mobile vehicle. This collection of positional data points may be used to calculate a geographical area represented by a convex hull 210. Convex hull 210 is defined as the smallest convex polygon for which each point in the polygon is either on the boundary or in its interior. Points 1-16 may form a set of coordinates representing an area in which a mobile vehicle user often drives. A convex hull may be computed by using geometrical algorithms operating on the set of coordinates, such as the so-called “Graham's scan” or “Jarvis's march”, which process vertices in the order of the polar angles they form with a reference vertex. Other convex-hull generation algorithms include, for example, an incremental method where points are sorted from left to right; a divide-and-conquer method where two convex hulls are computed recursively from two subsets of points; and a prune-and-search method where an upper chain is generated followed by the generation of a lower chain that are then connected. The convex hull may be generated from, for example, a few points of interest to a subscriber and points on a radius associated with each of the points.

The geographical area represented by convex hull 210 may help a telematics unit determine which broadcasts from satellite broadcast system 260, radio broadcast system 270, or wireless communication system 280 should be filtered for presentation to a mobile vehicle user.

Current technology allows broadcasters to include coded location data signals within a broadcast that are imperceptible to a human viewer or listener, but may be received by a telematics unit and other digital receivers. The digital signal processor of a telematics unit may be programmed to receive and interpret broadcast information that comprises information location coordinate data and at least one data string data. The information location coordinate data may comprise a longitude and a latitude associated with the broadcast information. The coordinate data may be transmitted as a data string. The broadcast data may be transmitted as a data string, or it may be transmitted in an analog mode. The DSP then may filter any broadcast based on the determination whether coordinates in the broadcast location data reside within the geographic area defined by the convex hull.

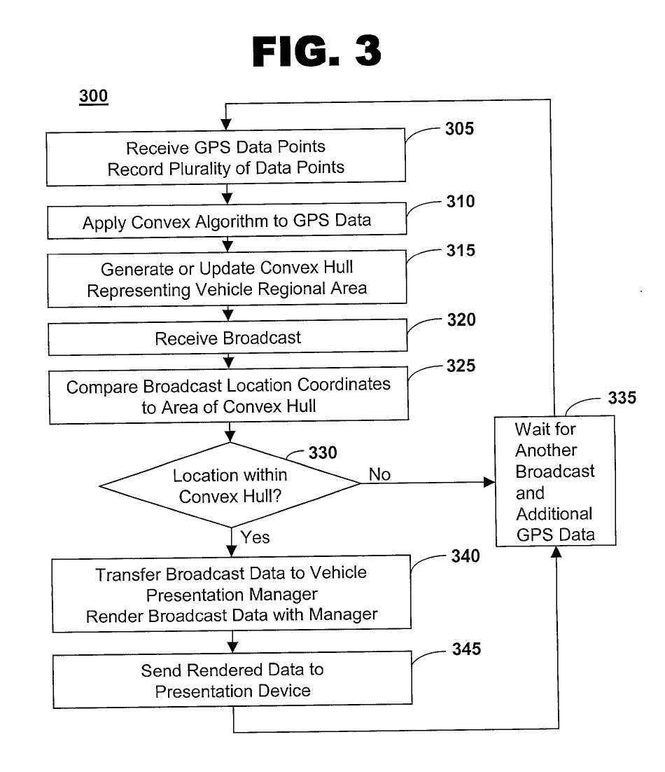

FIG. 3 shows a flow diagram of another embodiment of a method for filtering broadcast information using convex hulls, in accordance with the present invention at 300. Broadcast filtering method 300 illustrates the steps for gathering and evaluating GPS information from the GPS unit of a mobile vehicle, determining whether a broadcast with location data information is targeted for a specific region in which a mobile vehicle user typically travels, and for filtering and presenting those broadcasts that might be of interest to the mobile vehicle user.

The method of providing information to a mobile vehicle user may begin by the DSP of the in-vehicle telematics unit receiving and storing a plurality of geographical coordinates from the GPS unit (Block 305). The GPS data may be evaluated in a computer program where a convex hull generation algorithm is applied to the geographical coordinate points (Block 310).

A convex hull may be generated from the plurality of recorded vehicle location coordinates, (Block 315). The convex hull may represent a home travel area, i.e. a geographical region that the mobile vehicle user travels on a regular basis.

The convex hull may be updated, as needed, through the input of additional GPS coordinate data (Block 315). That coordinate data input may include a current vehicle location coordinate, a previous vehicle location coordinate and a recorded vehicle location coordinate input, which were sent from the GPS unit to the computer program in the DSP. The current vehicle location coordinate may determine, for example, one point in the convex hull. The current vehicle location coordinate may be used, for example, to determine which previously defined convex hulls to utilize, when more than one convex hull has been generated for a user. Previous vehicle location coordinates or recorded vehicle location coordinate input may be used to define the convex hull.

Additional coordinate inputs may be used to determine the establishment or updating of the convex hull. The coordinate input may include information on the collection period or time during which the data is to be collected, a collection frequency or how often the location coordinate data is to be taken within a collection period, a retention period or the period of time in which the program retains the vehicle location coordinate data used to generate the convex hull, and a GPS service quality indicator for providing an indication of the quality or accuracy of the GPS information received. The coordinate input also may include user location coordinate input with information on user-defined location preferences or options. These preferences may be received, for example, from a call to a human or virtual advisor at a telematics service call center. They also may be received from an in-vehicle application or a web page input where a telematics subscriber may set up user preferences for location-specific information. For example, the period and frequency for reading GPS position points may be defined by a user profile based on personal preferences. A user profile may indicate, for example, where a user wishes to receive broadcasted information.

For example, the user may wish to reset the coordinate input program after moving to a new geographical location. The user may wish to extend or enlarge the geographical location of the convex hull to include an area of interest. A user might click and drag the perimeter of a convex hull illustration on an in-vehicle application or a web page to a new desired shape that includes a geographical region or point of interest.

Once the determined convex hull has defined a home region of the mobile vehicle or telematics subscriber, broadcasted information may be filtered according to preferences associated with the convex hull. A computer application in the telematics unit may compare the information location coordinate data within a broadcast to the location information of a mobile vehicle or the convex hull to determine whether the telematics unit should render or process regionally targeted broadcast information for presentation to the mobile vehicle user.

The telematics unit may receive the broadcast (Block 320). The broadcast information may be received from one of a variety of broadcast services including radio data service, a radio broadcast data service, a satellite broadcast service, a radio broadcast service, and a wireless communications broadcast service.

The broadcast information may include location coordinate data that indicate the geographical area that the broadcast is trying to target. The information location coordinate data may include a longitude and a latitude associated with the broadcast information. The signal with location information data may be undetectable by human ear or eye.

For example, a broadcast with information on traffic and weather condition around Detroit, Mich., may include embedded data on the geographical area that should receive the information. The data may include a plurality of longitudinal and latitudinal coordinates bounding the area to which the broadcast is targeted.

A computer application in the DSP of the telematics unit may compare the location coordinates sent with the broadcast to those of the convex hull (Block 325). The broadcast location coordinates may or may not be located in the convex hull (Block 330). When they are not, the broadcast data may not be presented to the mobile vehicle user and the telematics unit may continue to monitor for other broadcasts that are targeted to the location of the mobile vehicle (Block 335). The telematics unit may continue to process additional GPS data from the GPS unit as determined by a schedule, an event handler, or other predetermined parameters. This allows for periodic or continual updates to the convex hull during vehicle operation (Block 315).

There are advantages with a broadcast being able to target a specific geographical location. One is that information that may not have value to a subscriber will not be presented. For example, an in-vehicle telematics unit in Chicago that receives broadcast signals targeted for the Detroit area may determine from the location coordinate data sent with the broadcast that the broadcast with information on local news, traffic and weather in Detroit is of no interest to a driver in Chicago. The converse also is true: the broadcast information may be filtered to ensure that a driver in Detroit receives up-to-date local and even specialized information. These targeted broadcasts may gain in granularity and specificity of marketing and advertising that is greater than typical broadcasts of local radio stations.

When the telematics unit determines that the information location coordinate data resides within a convex hull, the broadcast data may be transferred to a vehicle presentation manager application in the DSP, as seen at block 340. The vehicle presentation manager application may render the broadcast information appropriately for one or more presentation devices available in the mobile vehicle, as seen at block 340.

The manager application may send the broadcast data to a presentation device, which may be a visual display, an audio device, or an audio-visual display device (Block 345). Predefined user preferences saved in the telematics unit may determine which device to use when more than one is available.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of providing information to a mobile vehicle user comprising:
receiving broadcast information at the mobile vehicle, wherein the broadcast information comprises information location coordinate data;
determining whether the information location coordinate data resides within a convex hull; and
presenting the broadcast information to the mobile vehicle user based on the determination.

2. The method of claim 1 wherein the broadcast information is received from a broadcast service selected from a group consisting of a radio data service, a radio broadcast data service, a satellite broadcast service, a radio broadcast service, and a wireless communications broadcast service.

3. The method of claim 1 wherein the information location coordinate data comprises a longitude and a latitude associated with the broadcast information.

4. The method of claim 1 further comprising:
recording a plurality of vehicle location coordinates; and
generating the convex hull from the recorded vehicle location coordinates.

5. The method of claim 4 further comprising:
updating the convex hull based on a coordinate input.

6. The method of claim 5 wherein the coordinate input is selected from a group consisting of a current vehicle location coordinate, a previous vehicle location coordinate, a recorded vehicle location coordinate input, a collection period, a collection frequency, a vehicle location coordinate retention period, a global positioning service quality indicator, and a user location coordinate input.

7. The method of claim 1 further comprising:
transferring the broadcast information to a vehicle presentation manager;
rendering the broadcast information with the vehicle presentation manager; and
sending the broadcast information to a presentation device.

8. The method of claim 7 wherein the presentation device is selected from a group consisting of a visual display, an audio device, and an audio-visual display device.

9. A computer usable medium including a program for providing information to a mobile vehicle user comprising:
computer program code to receive broadcast information at the mobile vehicle, wherein the broadcast information comprises information location coordinate data;
computer program code to determine whether the information location coordinate data resides within a convex hull; and
computer program code to present the broadcast information to the mobile vehicle user based on the determination.

10. The computer usable medium of claim 9 wherein the broadcast information is received from a broadcast service selected from a group consisting of a radio data service, a radio broadcast data service, a satellite broadcast service, a radio broadcast service, and a wireless communications broadcast service.

11. The computer usable medium of claim 9 wherein the information location coordinate data comprises a longitude and a latitude associated with the broadcast information.

12. The computer usable medium of claim 9 further comprising:
computer program code to record a plurality of vehicle location coordinates; and
computer program code to generate the convex hull from the recorded vehicle location coordinates.

13. The computer usable medium of claim 12 further comprising:
computer program code to update the convex hull based on a coordinate input.

14. The computer usable medium of claim 13 wherein the coordinate input is selected from a group consisting of a current vehicle location coordinate, a previous vehicle location coordinate, a recorded vehicle location coordinate input, a collection period, a collection frequency, a vehicle location coordinate retention period, a global positioning service quality indicator, and a user location coordinate input.

15. The computer usable medium of claim 9 further comprising:
computer program code to transfer the broadcast information to a vehicle presentation manager;
computer program code to render the broadcast information with the vehicle presentation manager; and
computer program code to send the broadcast information to a presentation device.

16. The computer usable medium of claim 15 wherein the presentation device is selected from a group consisting of a visual display, an audio device, and an audio-visual display device.

17. A system for providing information to a mobile vehicle user comprising:
means for receiving broadcast information at the mobile vehicle, wherein the broadcast information comprises information location coordinate data and at least one data string;
means for determining whether the information location coordinate data resides within a convex hull; and
means for presenting the broadcast information to the mobile vehicle user based on the determination.

18. The system of claim 17 further comprising:
means for recording a plurality of vehicle location coordinates; and
means for generating the convex hull from the recorded vehicle location coordinates.

19. The system of claim 17 further comprising:
means for updating the convex hull based on a coordinate input.

20. The system of claim 17 further comprising:
means for transferring the broadcast information to a vehicle presentation manager;
means for rendering the broadcast information with the vehicle presentation manager; and
means for sending the broadcast information to a presentation device.
